(19) United States
(12) Patent Application Publication
(10) Pub. No.: US 2024/0076914 A1
(43) Pub. Date: Mar. 7, 2024

(54) LOCK ARRANGEMENT FOR MOTOR VEHICLE HOOD

(71) Applicant: AKWEL VIGO SPAIN SL, Vigo Pontevedra (ES)

(72) Inventors: Agustin REGUEIRO BLANCO, Vigo (ES); Javier GONZALEZ NOVO, Vigo (ES); Javier COUTO MAQUIEIRA, A Coruna (ES); Oscar VAZQUEZ CARBALLO, Vigo (ES); David MARTINEZ NOVAS, Vigo (ES)

(73) Assignee: AKWEL VIGO SPAIN SL, Vigo Pontevedra (ES)

(21) Appl. No.: 18/195,493

(22) Filed: May 10, 2023

(30) Foreign Application Priority Data
May 13, 2022 (FR) 2204574
May 24, 2022 (FR) 2204965

(51) Int. Cl. E05B 83/24; B62D 25/12; E05B 81/06; E05B 85/04

(52) U.S. Cl. CPC E05B 83/24; B62D 25/12; E05B 81/06; E05B 85/04

(57) ABSTRACT

The arrangement includes a latch pivotally mounted to cooperate with a catch, a lock member including a locking ratchet arranged to cooperate with the latch between initial and intermediate locking configurations of the latch, following at least one movement control action of the ratchet by an actuator, an ejector arranged to drive, with the ejection thereof, the pivoting of the latch and the lifting of the hood, the latch and the ejector forming an ejection member of the striker. During the movement of the ratchet from the initial configuration to the final configuration, the lock member is arranged to pivot the ejection member in an ejection direction against the resultant torque of the weight of the hood exerted on the ejector via the striker in order to enable the lifting of the hood.

The present invention relates to a lock arrangement for a motor vehicle opening, such as a motor vehicle front hood.

Having a compartment housing the engine which is closed by an opening commonly referred to as a hood at the front of an internal combustion engine motor vehicle is known per se.

Generally, such a hood includes a fixed edge pivotally mounted on the body by means of hinges known per se and a free edge provided with at least one striker arranged to cooperate with a lock arrangement provided on the body and making it possible to hold the hood in the closed position.

In order to meet the high requirements in the field of automobile safety, the lock arrangement can be actuated in two phases in order to prevent the hood from opening in an untimely manner while the motor vehicle is driving and being able to suddenly obstruct the automobile driver's view.

In conventional vehicles comprising an internal combustion engine housed in the front hood, the user of the motor vehicle firstly performs a first procedure which is performed away from the hood and by actuating a lever housed inside the vehicle passenger compartment which has the effect of actuating a mechanism for ejecting the hood into a slightly ajar configuration.

Then, in order to release the opening of the hood completely, the user performs a second procedure which requires them to leave the motor vehicle to actuate an actuation lever located under the hood, the placement of which varies according to the type of motor vehicle and the user often has to locate it “blindly” by sweeping their hand across.

In recent years, the fight against atmospheric pollution has led automobile manufacturers to develop electric vehicles in serial production including an electric engine as the sole drive means and wherein a battery is fitted in the floor of the body of these vehicles, thus freeing up the space conventionally occupied by the engine unit.

The space thus freed up at the front of the vehicle is used to form a trunk, for example for luggage. As this trunk is used at the front of the motor vehicle, it is commonly referred to using the expression “front trunk” or contracted to “frank”.

As such, it is understood that this new use of the front space of the motor vehicle has substantially modified the use and opening frequency of the front hood. Consequently, the conventional hood opening procedure requiring the user to leave the motor vehicle appears to be non-ergonomic and is perceived as awkward or even uncomfortable and also reflects a perception of poor quality of the motor vehicle.

An aim of the present invention is that of providing a lock arrangement which makes it possible to increase the convenience of use of a trunk equipped with a hood of a motor vehicle and adapt the operation thereof for frequent and regular use, while adhering to the inherent safety constraints of the automotive field.

From the prior art, a motor vehicle engine hood lock is already known comprising a fork-shaped latch which retains a striker of the engine hood and a locking ratchet which locks the latch in the closed position. The ratchet is actuated for example using an actuation lever to adopt sequentially with the striker a closing configuration of striker engagement by the fork and an unlocking striker release configuration for lifting the hood.

Generally, the lock furthermore comprises an ejector which is configured to interact with the latch which is pivoted by the ejector to a striker release position by the latch. The ejector is also elastically returned in the ejection direction by an ejection spring which makes it possible to eject the striker and lift the hood.

The drawback of the current solution proposed in the prior art is that the ejection of the striker and therefore the lifting of the hood occur suddenly. This sudden opening of the hood harms the overall perception of the perceived quality of the motor vehicle by the user.

### DESCRIPTION OF THE INVENTION

The aim of the present invention is that of remedying these drawbacks.

To this end, the invention relates to a lock arrangement of a motor vehicle hood, comprising a pivotally mounted latch and comprising a notch capable of cooperating with the hood by engaging a striker of the hood in the notch, a lock member comprising a locking ratchet arranged to cooperate with the latch between at least one initial locking configuration of the latch with the striker fully engaged and a final unlocking configuration of the latch with the striker fully released, following at least one movement control action of the ratchet by an actuator, an ejector arranged to drive, with the ejection thereof, the pivoting of the latch and the lifting of the hood, the latch and the ejector forming a striker ejection member, characterized in that during the movement of the ratchet from the initial configuration to the final configuration, the lock member is arranged to pivot the ejection member in an ejection direction against the resultant torque of the weight of the hood exerted on the ejector via the striker in order to enable the lifting of the hood.

Thanks to the invention, the hood is ejected by the ejector progressively and not suddenly with the release of an ejection spring. In other words, the lock member exerts a thrust on the ejection member in the ejection direction against said torque.

The lock arrangement according to the invention can comprise one or more of the following features.

In another preferred embodiment of the invention, the arrangement comprises an assistance module provided to assist with the force of lifting the hood against the resultant torque of the weight of the hood.

In another preferred embodiment of the invention, the assistance module comprises an assistance spring, coupled with the ejector tending to pivot the ejector in the ejection direction, which is undersized such that said assistance spring develops an elastic return torque always less than the resultant torque of the weight of the hood.

In another preferred embodiment of the invention, the ejector is mounted free in rotation.

In another preferred embodiment of the invention, the lock member comprises at least one arm for driving the ejection member to pivot the ejection member in an ejection direction.

In a preferred embodiment of the invention, the lock member is configured to drive the ejection member in the ejection direction until the final configuration is reached and is configured to allow the ejection member to pivot, from the final configuration, in the opposite direction under the effect of the resultant torque of the weight of the hood in the absence of external intervention on the vehicle hood.

In a preferred embodiment of the invention, the ratchet being arranged to cooperate with the latch in an intermediate locking configuration of the latch partially engaging the striker, the lock member is configured to allow the ejection member to pivot in the opposite direction, from the final configuration, until the intermediate configuration is reached under the effect of the resultant torque of the weight of the hood in the absence of external intervention on the vehicle hood.

In another preferred embodiment of the invention, the ratchet being arranged to cooperate with the latch in an intermediate locking configuration of the latch partially engaging the striker and being selectively movable from the initial configuration to the intermediate configuration following a first control action and from the intermediate configuration to the final configuration following a second control action, the lock member comprises a first arm for driving the ejection member during the first action and a second arm for driving the ejection member during the second action.

In another preferred embodiment of the invention, the latch comprises a staged profile delimiting the first and second catches cooperating with the ratchet respectively in the initial and intermediate configurations.

In another preferred embodiment of the invention, the latch comprises on the periphery thereof a bearing surface portion which extends from the second catch and the ratchet has on the periphery thereof a complementary bearing surface portion which cooperates by contact with the bearing surface portion of the latch in the final configuration.

In another preferred embodiment of the invention, the ratchet is selectively pivoting against an elastic strain between a first engagement position in the first catch, a second engagement position in the second catch, a third cooperation position by contact with the latch.

In another preferred embodiment of the invention, the arrangement comprises a safety lock movable relative to the ratchet and arranged to oppose the pivoting of the ratchet and the latch beyond the intermediate configuration following the first action.

In another preferred embodiment of the invention, the safety lock comprises proximal and distal parts which interact respectively with the latch and the ratchet to oppose the pivoting thereof beyond the intermediate configuration in an engagement position and to leave them free to travel into a disengagement position.

In another preferred embodiment of the invention, the distal part has the shape of a leg arranged to have a front wall for intercepting a functional gripping element of the ratchet in the engagement position and to have an opposite back wall which is extended by a hollow profile inside which the gripping element can move freely in the safety lock disengagement position.

In another preferred embodiment of the invention, during the first action, the safety lock is arranged to be driven, against the elastic strain, into an end engagement position wherein the safety lock is pivoted by the ratchet via the distal part thereof which tends to engage the proximal part further to abut against the latch, such that the safety lock produces self-locking of the ratchet and the latch by preventing them from pivoting beyond the intermediate configuration.

In another preferred embodiment of the invention, the proximal part has a general fork shape provided with a front arm and a rear arm and the latch bears a relief capable of engaging inside the fork to cooperate selectively with the rear arm to hold the safety lock in the initial configuration and to abut against the front arm in the intermediate configuration.

In another preferred embodiment of the invention, the safety lock is arranged to drive the ejection member in its movement in the ejection direction during the first action and the ratchet is arranged to drive the ejection member in its pivoting in the ejection direction during the second action.

In another preferred embodiment of the invention, the safety lock comprises the first drive arm cooperating with the ejector during the first action and the ratchet comprises the second drive arm cooperating with the latch during the second action.

In another preferred embodiment of the invention, the arrangement comprises a ratchet for holding the ejection member in the final configuration and/or in the intermediate configuration.

In another embodiment of the invention, the ratchet comprises at least one notch for holding a relief of the ejection member in the intermediate configuration.

In another preferred embodiment of the invention, the arrangement comprises an actuator provided with an actuator element controlled in movement by the actuator and connected to the ratchet to drive the ratchet in its pivoting movement, the safety lock is arranged to limit a movement travel of the element during the first control action, so as to limit a pivoting amplitude of the ratchet.

In another preferred embodiment of the invention, the actuator comprises a traction cable provided with an end forming the actuator element connected to the ratchet, the control action being a pulling action of the actuator element, for example the actuator element being formed by a guide pin inside a groove of the ratchet.

In another preferred embodiment of the invention, the latch is arranged in the initial configuration to hold the safety lock in the engagement position thereof against the elastic strain thereof and the safety lock is arranged to intercept the latch in pivoting during the first action to hold the latch and the ratchet in the intermediate configuration.

In another preferred embodiment of the invention, the ratchet and the safety lock are pivotally mounted independently of each other and are elastically actuated by elastic means in the same pivoting direction.

In another preferred embodiment of the invention, the latch and the ejector are connected to each other in order to pivot in a locked manner with respect to each other or the latch and the ejector are formed of one piece.

The invention also relates to a motor vehicle comprising a hood and a lock arrangement capable of cooperating with a striker mounted on the hood, characterized in that the arrangement is according to the invention and is mounted on a chassis of the motor vehicle.

Preferably, the actuator is electrically motorized.

The invention will be clearly understood and the advantages thereof will become more apparent, on reading the following detailed description of embodiments represented by way of non-limiting examples. The description refers to the appended drawings wherein:

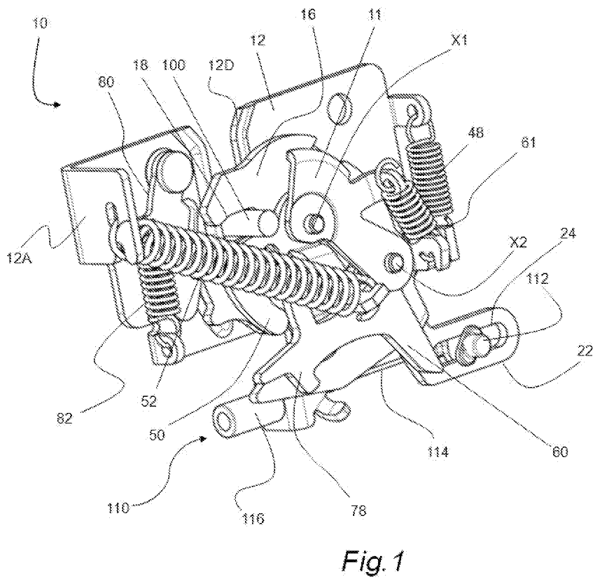

FIG. 1 is a perspective view of a lock arrangement according to the invention;

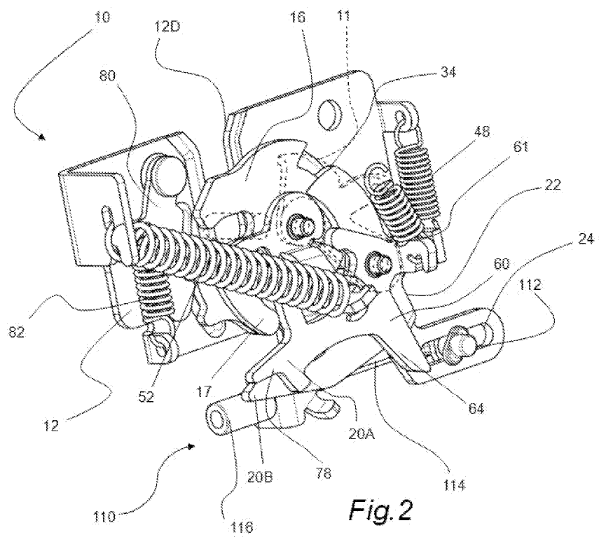

FIG. 2 represents the lock arrangement of FIG. 1, wherein a fairing element has been removed;

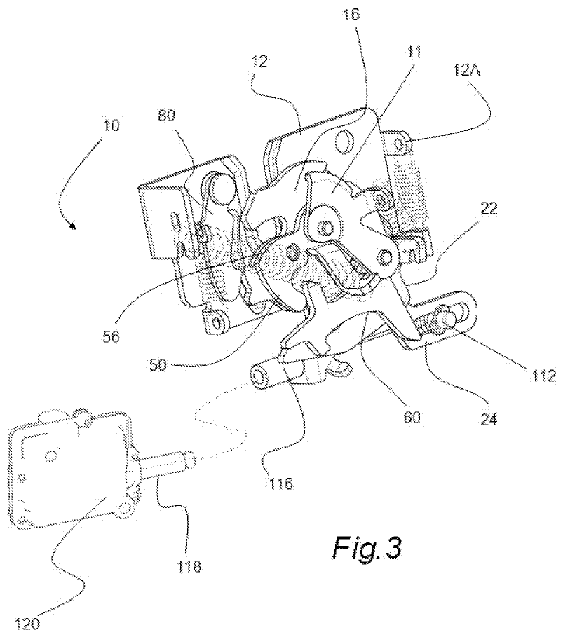

FIG. 3 is a perspective view of the lock arrangement of FIG. 2 and an actuator of the lock arrangement;

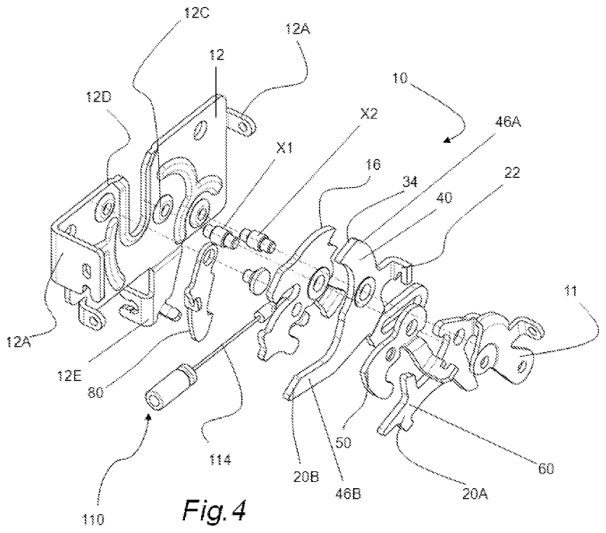

FIG. 4 is a perspective view of the lock arrangement of FIG. 1;

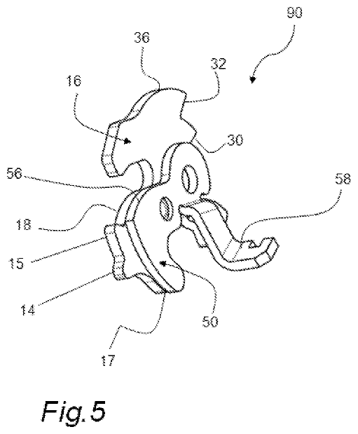

FIG. 5 is a perspective view of an ejection member of the lock arrangement of FIG. 1;

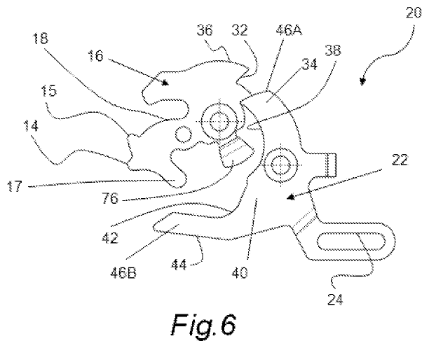

FIG. 6 is a front view of a latch and a locking ratchet of the latch of the lock arrangement of FIG. 1;

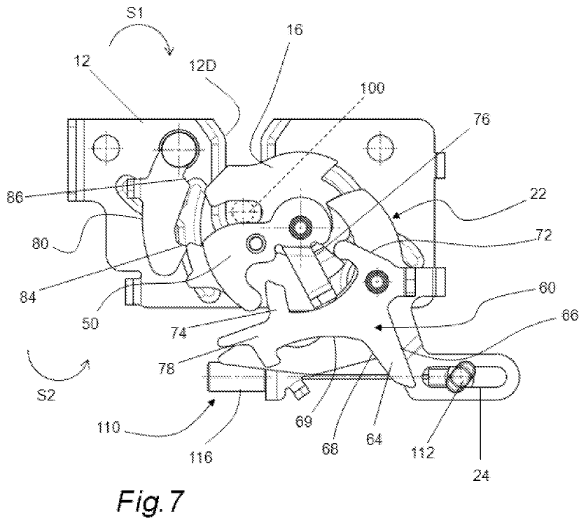

FIG. 7 is a front view of the lock arrangement in an initial locking arrangement;

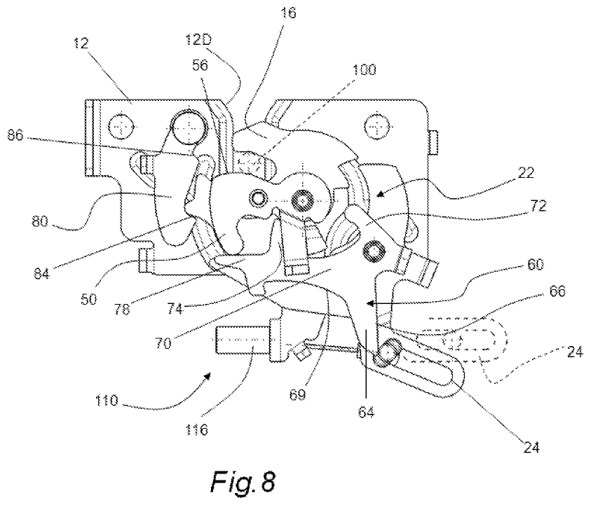

FIG. 8 is a front view of the lock arrangement in an intermediate locking configuration;

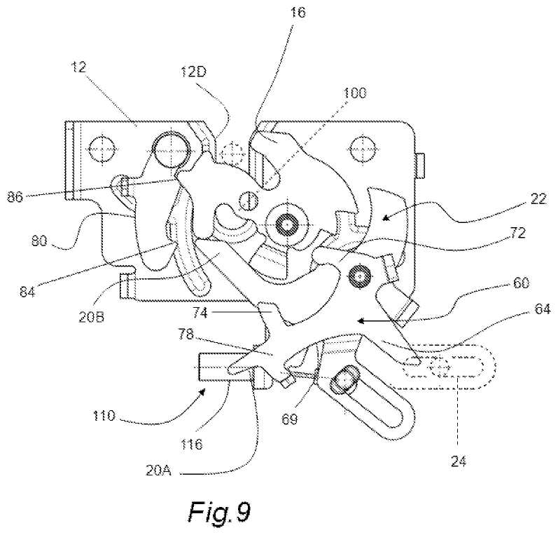

FIG. 9 is a front view of the lock arrangement in a final unlocking configuration;

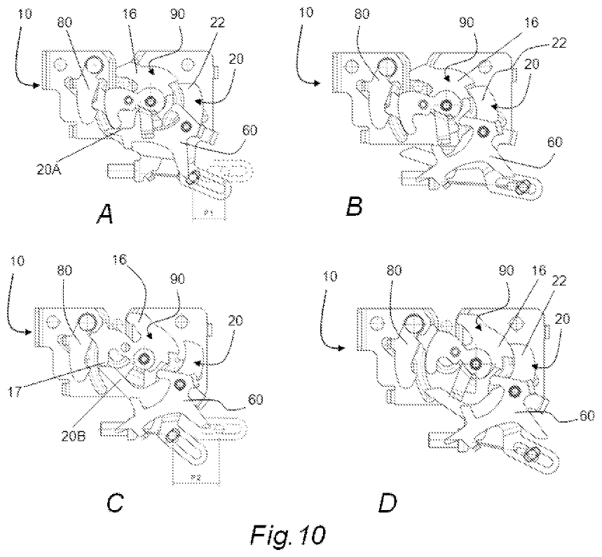

FIG. 10 illustrates found steps A to D of unlocking the lock arrangement of FIG. 1;

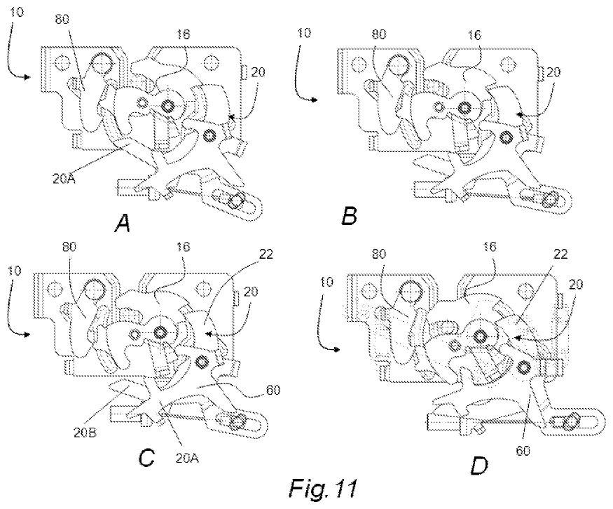

FIG. 11 illustrates four steps A to D of locking the lock arrangement of FIG. 1;

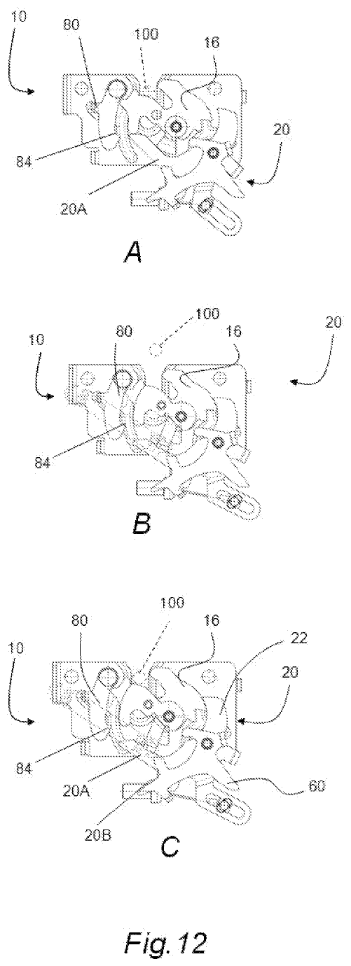

FIG. 12 illustrates three steps A to C of unlocking a variant of the lock arrangement of FIG. 1;

### DETAILED DESCRIPTION OF THE INVENTION

A lock arrangement for a motor vehicle hood according to the invention has been represented in FIGS. 1 to 11. The lock arrangement will be designated with the general reference 10.

As illustrated in FIG. 1, the arrangement 10 is configured to cooperate with a striker 100 (represented with broken line) fastened inside the motor vehicle hood (not shown in the figures). To this end, the arrangement 10 comprises a detent mechanism capable of cooperating with the striker 100 of the hood.

Preferably, as illustrated in the figures, the lock arrangement 10 furthermore comprises a plate 12 serving as a support for the detent mechanism and intended to be fastened to the vehicle. This plate 12 is for example made from a metal sheet, by cutting and/or bending said sheet. As illustrated in FIG. 1, the plate 12 further includes for example a plurality of fastening lugs 12A for elastic means such as springs of the detent mechanism 14, bent at right angles and a plurality of fastening holes 12B to the body.

According to the invention and as illustrated in detail particularly in FIG. 4, the lock arrangement 10 comprises a rotary latch 16 comprising a notch 18 capable of cooperating with the striker 100 of the hood.

The striker 100 is presented for example in the form of a hook closed in the manner of a ring. The hook 100 has for example a rectangular or square shape and the notch 18 of the latch 16 has a general hook shape to hold the striker 100.

In the example illustrated in the figures, the latch 16 is pivotally mounted about an axis X1 on the plate 12. This trunnion-shaped axis X1 can be fastened by screwing, welding and/or pressing onto an orifice 12C created in the plate 12.

Moreover, preferably, the plate 12 can have a fishmouth-shaped curved recess 12D open outwardly or in the shape of a U, intended to receive the striker 100 with a view to guiding toward the notch 18 of the latch 16.

Hereinafter in the description, terms with a directional meaning such as “front” and “rear” are used to denote the parts located respectively “at the top” and “at the bottom” with respect to the direct or clockwise direction of rotation referenced S1. Furthermore, the terms “distal” and “proximal” convey the fact that an element is removed from or near the latch 16.

The lock arrangement 10 furthermore comprises a lock member 20 comprising a locking ratchet 22. This locking ratchet 22 is arranged to cooperate with the latch 16 between at least an initial locking configuration of the latch 16 fully engaging the striker 100 and a final unlocking configuration of the latch 16 fully releasing the striker 100.

The switch from the initial configuration to the final configuration is carried out following at least one control action of the movement of the ratchet 22, performed for example by an actuation means of actuator 110. For example, the actuator 110 comprises an actuation element 112 coupled in driving with the ratchet 22 to pivot the ratchet 22 from the initial configuration to the final configuration.

For example, the actuator 110 comprises a traction cable 114, preferably movable in a duct 116 and the actuator element 112 is formed by an end piece of the traction cable 114, coupled with the ratchet 22. In this case, the movement action is a pulling action of the ratchet 22. For example, the actuator element 112 is presented in the form of a guide pin cooperating inside a guide groove 24 arranged on the ratchet 22. Thus, when the guide pin 112 abuts at the end of travel inside the guide groove 24 of the ratchet 22, it induces the movement of the ratchet 22 in the clockwise direction S1 against the elastic strain exerted by the action of the return spring 48 of the ratchet 22.

As illustrated in FIG. 3, the actuator 110 also comprises a housing 120 wherein an electric motor is arranged which drives a shaft via a gear arrangement (not seen in the figure). For example, the shaft acts at its end on a push rod 118 that can move longitudinally with respect to the housing 120, which for example cooperates with the traction cable 114.

In the example illustrated, the actuator element 110 is arranged to selectively pivot the ratchet 22 from the initial configuration to the intermediate configuration following a first pull of the cable and from the intermediate configuration to the final configuration following a second pulling action of the cable 114. In other words, the actuator 110 makes it possible to sequentially control the movement of the ratchet 22 from one configuration to the other via the first and second pulling actions of the cable 114.

Preferably, the locking ratchet 22 and the latch 16 cooperate together from the initial configuration to the final configuration via an intermediate locking configuration of the latch 16 partially engaging the striker 100. This thus makes it possible to unlock the lock arrangement 10 selectively from an initial locking configuration to an intermediate locking configuration, on one hand, then from the intermediate configuration to the final unlocking configuration, on the other.

Preferably, the actuator element 112 is arranged to selectively pivot the ratchet 22 from the initial configuration to the intermediate configuration following a first pull of the cable 114 and from the intermediate configuration to the final configuration following a second pulling action of the cable 114. In other words, the actuator 110 makes it possible to sequentially control the movement of the ratchet 22 from one configuration to the other via the first and second pulling actions of the cable 114.

Furthermore, as illustrated in FIG. 3, the plate 12 furthermore comprises a support lug 12E provided with a duct stop arranged to lock the duct 116 surrounding the control cable 114.

As illustrated in FIG. 6, the latch 16 comprises a staged profile delimiting the first 30 and second 32 catches cooperating with the ratchet 22 respectively in the initial and intermediate configurations. Preferably, the catches 30 and 32 delimit locking notches and the ratchet 22 preferably comprises a protruding projection 34 in the form of a locking lip which is capable of engaging in a complementary manner selectively in each locking notch of the catches 30 and 32 in the initial and intermediate locking configurations.

Furthermore, preferably, the latch 16 comprises on the periphery thereof a bearing surface portion 36 which extends from the second catch 32, for example substantially in the shape of the arc of a circle centered on the first axis X1. Moreover, preferably, the ratchet 22 has on the periphery thereof a complementary bearing surface portion 38, having the same center and a substantially identical radius of curvature arranged to cooperated by contact with the bearing surface portion 36 of the latch 16, when switching from the intermediate configuration to the final configuration.

Thus, the ratchet 22 is selectively pivoting against an elastic strain between a first engagement position in the first catch 30 of the latch 16, a second engagement position in the second catch 32 of the latch 16, and preferably in a third cooperation position by contact with the latch 16. In the example described, the three positions of the ratchet 22 are angularly distinct from each other.

In the example described, the ratchet 22 has a general curved main branch shape 40, for example crescent-shaped, which delimits a radially inner peripheral edge 42 and a radially outer peripheral edge 44 with respect to the general curvature of the branch 40.

In the example described, one of the ends 46A, 46B of the branch 40, here the rear end 46A of the branch 40, forms the protruding portion or locking lip 34 and the complementary bearing surface portion 38 is formed in the radially inner peripheral edge 42 of the branch 40. The branch 40 delimits an internal space of the inwardly curved inner side from which the latch 16 can pivot relative to the ratchet 22 from the intermediate configuration to the final configuration by cooperation by contact of their complementary bearing surfaces 36 and 38.

The ratchet 22 is for example pivotally mounted about a second axis X2. In this example, the ratchet 22 is pivoted by an elastic means 48 in the anti-clockwise direction S2 in FIG. 1. In the example illustrated, the elastic means 48 comprises a tension spring provided with a first end 48A coupled with the plate 12 and a second end 48B is coupled with the ratchet 22.

According to the invention, the arrangement 10 furthermore comprises an ejector 50 which interacts with the latch 16 such that the latch 16 is pivoted by the ejector 50. The ejector 50 and the latch 16 form an ejection member referenced 90 and illustrated in detail in FIG. 5.

To this end, according to the invention, the ejector 50 comprises a cam 56 for lifting the striker 100, and is arranged to drive, with the ejection thereof, the pivoting of the latch 16 and the lifting of the hood (FIG. 3). Preferably, the latch 16 and the ejector 50 are formed of one piece, for example by a welded assembly.

Alternatively, the latch 16 and the ejector 50 are formed by two separate parts which are connected to each other in order to rotate in a locked manner with a predetermined gap therebetween. For example, in this case, the latch 16 and the ejector 50 can be pivotally mounted with respect to each other about the first axis of rotation X1 and the striker 100 is trapped between a contact surface of the ejector 50 with the striker 100 and a corresponding contact surface of the latch 16 with the striker 100. The striker 100 is then clamped between the two contact surfaces of the latch 16 and the ejector 50 such that the pivoting of the ejector 50 in the ejection direction induces the movement of the striker 100 which moves the latch 16.

In particular, during the movement of the ratchet 22 from the initial configuration to the final configuration, the lock member 20 is arranged to pivot the ejection member 90 in an ejection direction against the resultant torque of the weight of the hood exerted on the ejector 50 via the striker 100 in order to enable the lifting of the hood and the pivoting of the latch 16.

Preferably, the lock member 20 comprises a drive element, having for example the form of a drive arm which is configured to exert a progressive strain on the ejection member 90 causing it to pivot in the ejection direction, against the resultant torque of the weight of the hood. Preferably, the actuator 110 is electrically motorized which thus makes it possible to obtain progressive kinematics of the drive of the ejector 50 by the ratchet 22 and therefore progressive hood lifting kinematics.

In the example illustrated, the lock arrangement 10 furthermore comprises a ratchet 80 for holding the ejection member 90 in the intermediate configuration and in the final configuration. As illustrated in FIG. 7, the ratchet 80 comprises a peripheral edge comprising a first catch 84 for holding the ejection member 90 in the intermediate configuration and a second catch 86 for holding the ejection member 90 in the final configuration. This makes it possible to prevent the ejection member 90 from pivoting with the effect of gravity in the opposite direction of ejection. In other words, this makes it possible to oppose the return of the ejection member 90 in the opposite direction of the ejection direction when the tensile strain of the cable 114 is released.

Preferably, the lock member 20 comprises a first drive arm 20A and a second drive arm 208 of the ejection member 90. Thus, the first drive arm 20A is configured to bring the ejection member 90 substantially facing the first holding catch 84 in the intermediate configuration. Then, the second drive arm 20B is configured to bring the ejection member 90 substantially facing the second holding catch 86 of the holding lever 80.

Preferably, the arrangement 10 comprises an assistance module provided to assist with the force of lifting the hood against the resultant torque of the weight of the hood. For example, the assistance module comprises an assistance spring 52, coupled with the ejector 50 tending to pivot the ejector 50 in the ejection direction, which is undersized such that said assistance spring 52 develops an elastic return torque always less than the resultant torque of the weight of the hood. Consequently, the release of the ejection member 90 by the locking ratchet 22 cannot drive the ejection of the ejection member 90 by the assistance spring 52. Indeed, on account of the assistance spring 52 being undersized, the elastic return torque exerted by the assistance spring 52 cannot oppose the resultant torque of the weight of the hood.

The assistance spring 52 is in this example a tension spring provided with a first end 52A coupled with the plate 12 and a second end 52B coupled with the ejector 50. For example, the ejector 50 comprises a support lug 58 of the end 52B of the assistance spring 52.

In a variant not illustrated, the ejector 50 can be mounted free in rotation without the assistance module. In this case, the motorized actuator 110 is calibrated in electric power such that the movement force exerted on the ejection member 90 by the lock member 20, via the drive arms 20A, 20B, makes it possible to compensate for the resultant torque of the weight of the hood.

Optionally, the lock arrangement 10 furthermore comprises a safety lock 60 elastically pivoted and mounted for example pivotally on the assembly plate 12. Preferably, the ratchet 22 and the lock 60 are pivotally mounted on a common pivoting axis, here the second axis X2 and are elastically actuated in the same anti-clockwise direction S2.

Preferably, the safety lock 60 is elastically pivoted from an engagement position wherein the safety lock 60 is arranged to oppose the pivoting of the ratchet 22 and the latch 16 beyond the intermediate configuration following the first control action to a disengagement position wherein the safety lock 60 allows the ratchet 22 and the latch 16 to reach the final configuration following the second control action.

Preferably, as described in detail hereinafter, the safety lock 60 is arranged in the engagement position to limit to a reduced travel the angular pivoting of the locking ratchet 22 during the first action and in the disengagement position to extend to a complete travel the angular pivoting of the ratchet 22 during the second action making it possible to reach the final unlocking configuration. Thus, according to the engagement or disengagement position of the safety lock 60, the angular pivoting travel of the locking ratchet 22 is respectively reduced or extended.

This makes it possible to prevent an overly wide angular amplitude movement of the ratchet 22 during the first action which might induce the switch directly from the initial configuration to the final configuration.

In the example described, the safety lock 60 is actuated by an elastic means 61 toward the disengagement position. In the example illustrated in FIG. 1, the elastic means 61 comprises a tension spring provided with a first end 61A rigidly coupled with the plate 12 and a second end 61B is coupled with the safety lock 60. In this example, the lock arrangement 10 comprises a fairing part 11 which is mounted rigidly connected to the plate 12 via the axis X1 and provided with a coupling lug of the end 61A of the spring 61.

Preferably, as illustrated in FIG. 7, the latch 16 is arranged to hold the safety lock 60 in the initial configuration against the elastic strain exerted by the elastic means 61 of the safety lock 60. Furthermore, the safety lock 60 is arranged to intercept the latch 16 in pivoting during the first pulling action in order to oppose the pivoting of the latch 16 in a release direction of the striker 100.

In the example illustrated, the safety lock 60 comprises a proximal part 62 and a distal part 70 which interact respectively with the latch 22 and the ratchet 16 to oppose the pivoting thereof beyond the intermediate configuration in the engagement position and to leave them free to travel into the disengagement position.

For example, the distal part 62 has the shape of a leg 64 arranged to have a front wall 66 for intercepting a gripping element of the ratchet 16 by the safety lock 60. In the example illustrated, the gripping element is formed by the actuator element 112 in the form of a guide pin and which forms a relief configured to engage with the leg 64 of the safety lock 60 during the pivoting of the ratchet 16.

Preferably, the leg 64 of the safety lock 60 is arranged to have an opposite back wall 68 which extends along a hollow profile 69 inside which the actuator element 112 can move freely in the release position of the safety lock 60. In this engagement position, the leg 64 is deviated from a movement trajectory of the actuator element 112 during the action movement action.

In the example described, the safety lock 60 is arranged to limit a movement travel of the element 112 during the first control action so as to limit a pivoting amplitude of the ratchet 22.

Furthermore, in the example described, the proximal part 70 arranged to intercept the latch 16 during the first pulling action in the engagement position thereof and to leave the latch 16 free to travel during the second pulling action in the disengagement position thereof.

Preferably, the proximal part 70 has a general shape of a fork provided with a rear arm 72 and a front arm 74 and the latch 16 bears a relief 76 capable of engaging inside the fork.

The relief 76 of the latch 16 cooperates with the fork of the safety lock 60, on one hand, to hold the safety lock 60 in the engagement position thereof by the rear arm 72 in the initial configuration (illustrated in FIG. 7) and, on the other, to abut against the front arm 74 in the intermediate configuration (illustrated in FIG. 8) following the pivoting of the safety lock 60 against the elastic strain thereof.

Preferably, during the first action, the safety lock 60 is arranged to be driven, against the elastic strain thereof, into an end engagement position wherein the safety lock 60 is pivoted by the ratchet 22 via the distal part 62 which tends to engage the proximal part 70 more to abut against the latch 16. The safety lock 60 then produces self-locking of the ratchet 16 and the latch 22 preventing them from pivoting beyond the intermediate configuration. This self-locking is maintained under the movement force of the actuator 110 exerted on the actuator element 112 is released.

The actuator element 112 engages with the safety lock 60, here the distal part 62 of the safety lock 60 and pivots the ratchet 16 and the safety lock 60 together during the first pull of the cable.

During the first pull of the cable, the actuator element 112 engages with the safety lock 60, here the distal part 62 of the safety lock 60 and pivots the ratchet 22 and the safety lock 60 rigidly connected.

In the example described, after releasing the pulling force of the first action, the actuator element 112 is then pushed in an opposite direction to the pulling direction inside the guide groove 24 of the ratchet 22, for example by being pushed in the groove 24 by its own spring or by the safety lock 60 via the leg 64. The actuator element 112 can for example be pushed in the opposite direction to the pulling direction by the safety lock 60 which is elastically returned to the disengagement position or optionally by elastic return means known per se.

This has the effect of releasing the leg 64 of the safety lock 60 which is then free to pivot in the anti-clockwise direction S2 by elastic return until the disengagement position is reached.

In the disengagement position, the safety lock 60 is positioned such that it has the hollow profile 69 thereof inside which the actuator element 112 can move until the ratchet 22 pivots in the final configuration during the second pulling action. During the second pull of the cable, the actuator element 112 moves inside the hollow profile 69 of the safety lock 60, and pivots the ratchet 22 to the final configuration.

As seen in FIG. 9, the first drive arm 20A is formed by a front end extension branch 78 of the safety lock 60 which delimits a guide surface configured to cooperate with the ejection member 90 from the initial configuration to the intermediate configuration (FIG. 8).

As seen clearly in FIG. 9, the second drive arm 20B is formed by the front end 46B of the branch 40 of the ratchet 22 which forms a guide and bearing surface of the ejection member 90.

To this end, preferably, the latch 16 furthermore comprises a protruding nose-shaped projection 17 which is arranged to cooperate with the drive arm(s) 20A and 20B.

The main aspects of operation of the invention will now be described with reference to FIGS. 10 and 11.

In FIG. 10, steps A to D of lifting and unlocking the hood of the motor vehicle by the lock arrangement 10 according to the invention have been represented. Initially, the lock arrangement 10 is in the initial locking configuration illustrated in FIG. 7.

In this initial configuration, the latch 16 is fully engaged with the striker 100 of the hood of the motor vehicle and cooperates with the ratchet 22 by the first catch 30 thereof. Furthermore, the safety lock 60 extends into the initial engagement position thereof. In this initial engagement position, the leg 64 is deployed via a pulling trajectory of the actuator element 112. Furthermore, the relief 76 of the latch 16 makes it possible to hold the safety lock 60 in this initial position by the rear arm 72 of the safety lock 60 which abuts against this relief 76 by the elastic strain in the anti-clockwise direction S2.

The user then seeks to open the hood of the motor vehicle. During a first step (FIG. 10A), they control the actuator 110 to perform a first movement action of the element 112 by pulling the cable 114. The element 112 is then moved inside the guide groove 24 of the ratchet 22 until the element 112 is intercepted by the leg 64 of the safety lock 60.

During this first action illustrated by FIG. 103, the actuator element 112 engages with the leg 64 which induces the pivoting of the safety lock 60 in the clockwise direction 61 against the elastic strain of the safety lock 60 until an end engagement position is reached. The actuator element 112 is limited in the movement thereof to a pulling travel P1 by the safety lock 60 (FIG. 10A).

In this end engagement position, the lock 60 presents the drive arm 78 thereof to pivot the ejector 50 and the latch 16 in the ejection direction of the striker 100 until a part of the assembly formed by the ejector 50 and the latch 16 is engaged in the first catch 84 of the holding lever 84.

Preferably, the pivoting of the ejection member 90 is assisted by the assistance spring 52 which exerts an elastic return torque of the ejector 50 in the ejection direction.

Furthermore, the ratchet 22 is pivoted by the effect of puffing the actuator element 112 which abuts at the end of travel inside the guide groove 24 and causes the pivoting of the ratchet 22 against the electric strain in the clockwise direction S1. Thus, the latch 16 by being disengaged from the ratchet 22 can pivot freely in the clockwise release direction S1 while being for example driven by the ejector 50. This has the effect of partially disengaging the striker 100 from the latch 16. During the pivoting of the latch 16, the relief 76 of the latch 16 engaged inside the two-armed fork 62 of the safety lock 60 abuts against the front arm 74 of the safety lock 60 which is located at the end engagement position. During the same pivoting of the latch 16, the locking lip 34 of the ratchet 22 engages inside the second catch 32 of the latch 16.

Following this step 10B, the ratchet 22 is then disengaged from the first catch 30 and is engaged in the second catch 32 of the latch 16 and the latch 16 is in a partial engagement position of the striker 100. Furthermore, the ejection member 90 is held by the first catch 84 of the holding ratchet 80, for example by a first protruding part 14 of the peripheral edge of the latch 16.

Moreover, as seen in FIG. 10B, the pulling of the actuator element 112 is released. The ratchet 22 having pivoted in a second position in the clockwise direction S1 switching from the first catch 30 to the second catch 32, the actuator element 112 is pushed inside the guide groove 24 in an opposite direction to the pulling direction which frees the leg 64 of the safety lock 60 which is then elastically returned to the disengagement position thereof. The ratchet 22 and the latch 16 are then located in the intermediate partial disengagement configuration of the striker 100 (FIG. 8).

During a second step (FIG. 10C), the user controls the actuator 110 to perform a second movement action of the element 112 by pulling the cable 114. The element 112 is then moved inside the guide groove 24 of the ratchet 22 until it abuts at the end of travel in the guide groove 24 and induces the pivoting of the ratchet 22 in the clockwise direction S1 (FIGS. 10B, 10C). The ratchet 22 is then disengaged from the second catch 34.

In this case, the pulling of the actuator element 112 is not limited by the leg 64 of the safety lock 60 which is in the disengagement position thereof. On the other hand, the actuator element 112 can extend the movement thereof to a pulling travel P2 inside the hollow profile 69 of the safety lock 60 which is in the disengagement position. This induces the pivoting of the ratchet 22 which will then pivot the ejection member 90 by the drive arm 203 formed by the front end 46B of the branch 40 of the ratchet 22.

This has the effect of pivoting the ejector 50 and the latch 16 until the release of the catch 100 from the notch 18 of the latch 16 such that the latch 16 engages a second protruding part 15 of the peripheral edge thereof in the second holding catch 86 of the holding ratchet 80 of the ejection member 90. The latch 16 and the ratchet 22 are then in the final unlocking configuration thereof (FIG. 9). In a non-illustrated variant of the invention, the parts 14 and 15 of the latch 16 can be formed by a single rib.

In this example, the latch 16 pivots inside the curved space delimited by the peripheral inner edge of the ratchet 22 and the bearing surface portion in the shape of an arc of a circle of the latch 16 cooperates by contact with the complementary bearing surface portion of the ratchet 22. The latch 16 is then pivoted by the ejector 50 until the striker 100 is released from the notch 18 (FIG. 10D).

In FIG. 11, steps A to D of closing the hood of the motor vehicle have been represented. Initially, the lock arrangement 10 is in the final configuration illustrated by FIG. 9.

In this configuration, the latch 16 is fully released from the striker 100. The latch 16 is held in this release position by the second catch 86 of the holding ratchet 80. As the latch 16 and the elector 50 are locked in movement with respect to each other or are formed of one piece, the ejector 50 is also in an ejected position wherein the assistance spring 52 exerts an elastic return torque in this ejected position. Furthermore, the ratchet 22 and the latch 16 cooperate together by contact by the complementary bearing portions thereof.

Then, during a step 11A, the user of the motor vehicle applies a force on the vehicle hood such that the striker 100 transmits this force to the lifting cam 56 of the ejector 50.

This has the effect of disengaging the latch 16 from the second holding catch 84 which pivots relative to the ratchet 22 by guiding the respective bearing portions thereof until the engagement of the locking lip 34 of the ratchet 22 inside the second locking notch 32 of the latch 16.

Finally, during step 11D, the continuation of the force exerted on the hood of the motor vehicle induces the pivoting of the ejection member 90 until the latch 16 passes the first holding catch 84 of the ratchet 80. The continuation of the pivoting of the latch 16 also leads the ratchet 22 to disengage from the second catch 32 until the first catch 30 is reached. Furthermore, the pivoting of the latch 16 also engages the relief inside the fork of the safety lock 60 which is then driven from the disengagement position thereof to the engagement position thereof again the elastic strain thereof, in the forward direction S1.

In FIG. 12, three steps (A, B, C) of unlocking a variant of the lock arrangement 10 have been represented. In this variant, the holding ratchet 80 is devoid of the second catch 86 for holding the latch 16 in the final configuration. The ratchet 80 comprises in this variant only the first catch 84 for holding the latch 16 in the intermediate configuration. In this case, the latch 16 is driven successively by the drive arm(s) of the lock member 20 until the intermediate configuration is reached from the final configuration (step A) of releasing the striker 100. In this illustrated example, the latch 16, and therefore the ejection member 90, is driven in the intermediate configuration by the drive arm 78 of the safety lock 60 until it cooperates with the first holding catch 84 of the ratchet 80 by a first pulling action then is driven in the final configuration by the drive arm 20B of the ratchet 22 by a second pulling action.

The lock member 20 is arranged to pivot the ejection member 90 in an ejection direction against the resultant torque of the weight of the hood exerted on the ejector 50 via the striker 100 in order to enable the lifting of the hood.

The user can then decide to completely open the vehicle hood (step B) as the striker 100 is then fully released from the notch 18.

If the user ultimately decides not to open the vehicle hood or is prevented from doing so, this variant offers an additional safety guarantee. As the holding ratchet 80 has no catch for holding the ejection member 90 in the final configuration, when the drive arm 20B of the ratchet 22 is returned elastically with the ratchet 22, the ejection member 90 is no longer supported by the drive arm 20B in the final configuration thereof. The ejection member 90 is then pivoted, from the final configuration, by the effect of the resultant torque of the weight of the hood exerted by the bearing of the striker 100 on the ejection member 90, and in particular, on the lifting cam 56 of the ejector 50.

In this case, the lock member 20 is configured to allow the ejection member 90 to pivot in the opposite direction under the effect of the resultant torque of the weight of the hood in the absence of external intervention on the vehicle hood.

Preferably, the lock member 20 is configured to allow the ejection member 90 to pivot in the opposite direction until the intermediate configuration is reached under the effect of the resultant torque of the weight of the hood in the absence of external intervention on the vehicle hood. In the example illustrated, the rotation of the ejection member 90 in the opposite direction to the ejection direction automatically brings the latch 16 to the intermediate catch 84 of the holding ratchet 80.

This makes it possible to further improve the safety of the lock arrangement as a new movement control action must be sent to eject the striker 100 and help open the hood.

Obviously, the invention is not limited to the embodiments described above. Other embodiments within the grasp of a person skilled in the art can also be envisaged without leaving the scope of the invention defined by the claims hereinafter. In particular, in the present description, the elastic means described comprise tension springs, but alternatively, the elastic means can comprise torsion springs or any other elastic means known in the prior art.

1. A lock arrangement for a motor vehicle hood, comprising a pivotally mounted latch and comprising a notch capable of cooperating with the hood by engaging a striker of the hood in the notch, a lock member comprising a locking ratchet arranged to cooperate with the latch between at least one initial locking configuration of the latch with the striker fully engaged and a final unlocking configuration of the latch with the striker fully released, following at least one movement control action of the ratchet by an actuator, an ejector arranged to drive, with the ejection thereof, the pivoting of the latch and the lifting of the hood, the latch and the ejector forming a striker ejection member, wherein during the movement of the ratchet from the initial configuration to the final configuration, the lock member is arranged to pivot the ejection member in an ejection direction against the resultant torque of the weight of the hood exerted on the ejector via the striker in order to enable the lifting of the hood.

2. The arrangement according to claim 1, comprising an assistance module provided to assist with the force of lifting the hood against the resultant torque of the weight of the hood.

3. The arrangement according to claim 2, wherein the assistance module comprises an assistance spring, coupled with the ejector tending to pivot the ejector in the ejection direction, which is undersized such that said assistance spring develops an elastic return torque always less than the resultant torque of the weight of the hood.

4. The arrangement according to claim 1, wherein the ejector is mounted free in rotation.

5. The arrangement according to claim 1, wherein the lock member comprises at least one arm for driving the ejection member to pivot the ejection member in an ejection direction.

6. The arrangement according to claim 1, wherein the lock member is configured to drive in the ejection direction the ejection member until the final configuration is reached and is configured to allow the ejection member to pivot, from the final configuration, in the opposite direction under the effect of the resultant torque of the weight of the hood in the absence of external intervention on the vehicle hood.

7. The arrangement according to claim 6, wherein the ratchet being arranged to cooperate with the latch in an intermediate locking configuration of the latch partially engaging the striker, the lock member is configured to allow the ejection member to pivot from the final configuration in the opposite direction, until the intermediate configuration is reached under the effect of the resultant torque of the weight of the hood in the absence of external intervention on the vehicle hood.

8. The arrangement according to claim 1, wherein the ratchet being arranged to cooperate with the latch in an intermediate locking configuration of the latch partially engaging the striker and being selectively movable from the initial configuration to the intermediate configuration following a first control action and from the intermediate configuration to the final configuration following a second control action, the lock member comprises a first arm for driving the ejection member during the first action and a second arm for driving the ejection member during the second action.

9. The arrangement according to claim 8, wherein the latch comprises a staged profile delimiting the first and second catches cooperating with the ratchet respectively in the initial and intermediate configurations.

10. The arrangement according to claim 9, wherein the latch comprises on the periphery thereof a bearing surface portion which extends from the second catch and the ratchet has on the periphery thereof a complementary bearing surface portion which cooperates by contact with the bearing surface portion of the latch in the final configuration.

11. The arrangement according to claim 9, wherein the ratchet is selectively pivoting against an elastic strain between a first engagement position in the first catch, a second engagement position in the second catch, a third cooperation position by contact with the latch.

12. The arrangement according to claim 8, comprising a safety lock movable relative to the ratchet and arranged to oppose the pivoting of the ratchet and the latch beyond the intermediate configuration following the first action.

13. The arrangement according to claim 1, wherein the safety lock comprises proximal and distal parts which interact respectively with the latch and the ratchet to oppose the pivoting thereof beyond the intermediate configuration in an engagement position and to leave them free to travel into a disengagement position.

14. The arrangement according to claim 13, wherein the distal part has the shape of a leg arranged to have a front wall for intercepting a functional gripping element of the ratchet in the engagement position and to have an opposite back wall which is extended by a hollow profile inside which the gripping element can move freely in the safety lock disengagement position.

15. The arrangement according to claim 13, wherein during the first action, the safety lock is arranged to be driven, against the elastic strain, into an end engagement position wherein the safety lock is pivoted by the ratchet via the distal part thereof which tends to engage the proximal part further to abut against the latch, such that the safety lock produces self-locking of the ratchet and the latch by preventing them from pivoting beyond the intermediate configuration.

16. The arrangement according to claim 13, wherein the proximal part has a general fork shape provided with a front arm and a rear arm and the latch bears a relief capable of engaging inside the fork to cooperate selectively with the rear arm to hold the safety lock in the initial configuration and to abut against the front arm in the intermediate configuration.

17. The arrangement according to claim 12, wherein the safety lock is arranged to drive the ejection member in its movement in the ejection direction during the first action and the ratchet is arranged to drive the ejection member in its pivoting in the ejection direction during the second action.

18. The arrangement according to claim 1, wherein the safety lock comprises the first drive arm cooperating with the ejector during the first action and the ratchet comprises the second drive arm cooperating with the latch during the second action.

19. The arrangement according to claim 1, comprising a ratchet for holding the ejection member in the intermediate configuration and/or in the final configuration.

20. The arrangement according to claim 19, wherein the ratchet comprises at least one notch for holding a relief of the ejection member in the intermediate configuration.

21. The arrangement according to claim 1, comprising an actuator provided with an actuator element controlled in movement by the actuator and connected to the ratchet to drive the ratchet in its pivoting movement, the safety lock is arranged to limit a movement travel of the element during the first control action, so as to limit a pivoting amplitude of the ratchet.

22. The arrangement according to claim 21, wherein the actuator comprises a traction cable provided with an end forming the actuator element connected to the ratchet, the control action being a pulling action of the actuator element, for example the actuator element being formed by a guide pin inside a groove of the ratchet.

23. The arrangement according to claim 1, wherein the latch is arranged in the initial configuration to hold the safety lock in the engagement position thereof against the elastic strain thereof and the safety lock is arranged to intercept the latch in pivoting during the first action to hold the latch and the ratchet in the intermediate configuration.

24. The arrangement according to claim 1, wherein the ratchet and the safety lock are pivotally mounted independently of each other and are elastically actuated by elastic means in the same pivoting direction.

25. The arrangement according to claim 1, wherein the latch and the ejector are connected to each other in order to pivot in a locked manner with respect to each other or the latch and the ejector are formed of one piece.

26. A motor vehicle comprising a hood and a lock arrangement capable of cooperating with a striker mounted on the hood, wherein the arrangement is according to claim 1 and is mounted on a chassis of the motor vehicle.

27. The motor vehicle according to claim 26, wherein the actuator is electrically motorized.
